(19) United States
(12) Patent Application Publication
(10) Pub. No.: US 2001/0002152 A1
(43) Pub. Date: May 31, 2001

(54) Optical scanner assembly

(76) Inventors: Mitsuhiro Ohno, Ohmiya-shi (JP); Hiromitsu Yamakawa, Ohmiya-shi (JP)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/725,831

(22) Filed: Nov. 29, 2000

(30) Foreign Application Priority Data
Nov. 30, 1999 (JP) 1999-341150

(51) Int. Cl. G02B 26/08

(52) U.S. Cl. 359/204; 359/216

(57) ABSTRACT

An optical scanner assembly includes a plurality of laser beams emitted from a laser light source reflected by a polygonal mirror and incident upon a multi-sided splitter mirror containing two adjacent reflective sides of a polygon, such as a square. The top of the multi-sided splitter mirror is arranged on the incidence center axis, and the aforementioned plurality of laser beams are split to be incident upon two reflective surfaces with the top interposed therebetween.

### BACKGROUND OF THE INVENTION

1. Field of the Invention

The present invention relates to optical scanner assemblies suitable for use in an imaging device which scans a laser beam across each of a plurality of image carriers such as photosensitive drums to form electrostatic latent images in the same or different colors on each of the image carriers and which then transfers sequentially toner images formed of the latent images onto a transfer medium, while the transfer medium is being moved, to form desired images thereon. More particularly, the present invention relates to a multi-sided splitter mirror for forming optical paths which serve to split and direct a laser beam emitted from a laser source to each of the image carriers.

2. Description of the Related Art

Tandem imaging devices are widely known as the color-imaging devices for use in color copiers or color printers. The imaging device is adapted to have a plurality of image carriers such as photosensitive drums in tandem with one another, across each of which a laser beam is scanned to form an electrostatic latent image thereon. The electrostatic latent image is developed with a predetermined toner to form a toner image, which is in turn transferred sequentially onto a transfer medium such as recording paper to form a color image thereon, the medium being moved in the tandem direction of the image carriers.

Typical imaging devices of this type include an optical scanning system disclosed in Japanese Patent Laid-Open Publication No. H 11-295625. Such a typical tandem imaging device is adapted to scan the laser beams, which are emitted from four laser light sources and representative of image data of Y (yellow), M (magenta), C (cyan), and BK (black), across four photosensitive drums via optical scanner systems corresponding to each of the laser beams to expose the image on each of the photosensitive drums to form an electrostatic latent image thereon.

Such a color-imaging device is provided with an optical scanner system for each of a plurality of photosensitive drums, thus making it difficult to decrease the size of the system and causing an increase in cost. This leads to color imaging devices which share a single optical scanner system among a plurality of photosensitive drums to reduce the size of the system. Such a system is disclosed in Japanese Patent Laid-Open Publication Nos. H 6-286226, 10-20608, and 10-133131. The optical scanner assembly used in the color imaging devices is adapted to deflect the laser beams emitted from a plurality of laser light sources corresponding to the number of a plurality of photosensitive bodies toward a splitter means using a deflector means that is shared for deflection, the splitter means guiding each of the laser beams into each of the photosensitive bodies.

FIGS. 4 and 5 illustrate the schematic structure of an optical scanner assembly used in prior-art color imaging devices of this type. The optical scanner assembly has a structure in which four laser beams emitted from a laser light source 1 (FIG. 5) formed of a semiconductor laser array are collimated by a collimator lens 2 and a cylindrical lens 4 and are sequentially reflected by the first reflector 3 and the second reflector 5 to be incident upon a polygonal mirror 6 or a deflector means which has reflective surfaces formed on substantially equilateral hexagonal sides and is rotated at an appropriate speed. The laser beam reflected by the polygonal mirror 6 goes through an fθ lens 7 to be incident upon a splitter means or a multi-sided splitter mirror 8. As shown in FIG. 4, the laser beam incident thereon as a collimated beam is reflected by the multi-sided splitter mirror 8 to be split into four directions. The laser beams reflected by the multi-sided splitter mirror 8 into four directions are each reflected and collimated by a first cylindrical mirror 11, a second cylindrical mirror 12, a third cylindrical mirror 13, and a fourth cylindrical mirror 14, and then incident upon four photosensitive drums (not shown) to form electrostatic latent images thereon, respectively. The photosensitive drums are rotated at appropriate speeds and thus the rotation will cause the positions where the electrostatic latent images are formed to change sequentially. In addition, the rotation of the polygonal mirror 6 causes the position of the laser beams incident on the multi-sided splitter mirror 8 to change sequentially, which in turn causes the position of the laser beams incident on the photosensitive drums to change sequentially. At this time, it is to be understood that the scan direction produced by a change in the position of the laser beams incident on the photosensitive drums, the change being caused by the rotation of the polygonal mirror 6, is the main scan direction, while the scan direction produced by a change in the position of incidence of the laser beams, the change being caused by the rotation of the photosensitive drums, is the sub scan direction.

As shown in FIG. 6, the multi-sided splitter mirror 8 is provided with four reflective surfaces 8a, 8b, 8c, 8d, which have angles different from each other and reflect luminous fluxes incident on the multi-sided splitter mirror 8 from the fθ lens 7. The multi-sided splitter mirror 8 has a lower reflector portion 9a shaped generally in a trapezoid in cross section and an upper reflector portion 9b which is shaped generally in an isosceles triangle in cross section and which is superimposed on the upper side of the trapezoid. The equilateral sides of the upper reflector portion 9b form a larger angle than the sides of the lower reflector portion 9a with respect to a straight line which passes through the top of the isosceles triangle and which is parallel to incident laser beams. In addition, the sides of the lower reflector portion 9a form the reflective surfaces 8a, 8d, while the equilateral sides of the upper reflector portion 9b form the reflective surfaces 8b, 8c. The laser beams reflected by the reflective surfaces 8a, 8d as well as the laser beams reflected by the reflective surfaces 8b, 8c are adapted to be symmetric, respectively, with respect to the line which passes through the top of the isosceles triangle and which is parallel to the incident laser beams. Accordingly, the first cylindrical mirror 11 (FIG. 4) and fourth cylindrical mirror 14 as well as the second cylindrical mirror 12 and third cylindrical mirror 13 are arranged to be symmetric with respect to the line. Moreover, the position of the cylindrical mirrors 11, 12, 13, 14 is determined so as to make substantially equal to each other the optical path lengths from the laser light source 1 to each of the photosensitive drums via each of the cylindrical mirrors 11, 12, 13, 14.

Furthermore, there is provided a sensor mirror 15 (FIG. 5) near outside the range of scan in the main scan direction, and the sensor mirror 15 reflects a laser beam reflected by the polygonal mirror 6 toward a scan position sensor 16. When a laser beam is incident on the scan position sensor 16, an electrostatic latent image starts to be formed on the photosensitive drums at an appropriate timing.

However, the optical scanner assembly used in the aforementioned prior-art imaging devices is adapted to split a laser beam into four directions by the multi-sided splitter mirror 8, the laser beam being transmitted and adjusted through the optical scanner system that is shared to reduce the size of the imaging device. The multi-sided splitter mirror 8 has the four reflective surfaces 8a, 8b, 8c, 8d, thus leading to the following problems. The four reflective surfaces 8a, 8b, 8c, 8d have different angles and the laser beams have to be reflected to have the optical paths of substantially the same length in relation to the cylindrical mirrors 11-14. Accordingly, machining the four reflective surfaces 8a, 8b, 8c, 8d requires high accuracy to ensure that the beams of light reflected therefrom are incident upon the cylindrical mirrors 11-14. Thus, this may provide difficulty in the machining and cause an increase in the cost thereof. This leads to an increase in manufacturing cost of imaging devices employing the optical scanner assembly, regardless of the reduction in size of the optical scanner assembly.

### SUMMARY OF THE INVENTION

In view of the foregoing problems, an object of the present invention is to provide an optical scanner assembly which comprises a multi-sided splitter mirror having such a structure as to facilitate machining with high accuracy, thereby reducing the parts in cost, and which is made suitable for imaging devices that are reduced in cost and size.

As technical means for achieving the object, the present invention provides an optical scanner assembly for guiding a plurality of light beams into a deflector means and splitting the light beams reflected by the deflector means into a plurality of directions by a splitter means to scan each of the light beams across a plurality of scanned bodies. The optical scanner assembly is characterized in that the splitter means is formed of two reflective surfaces forming appropriate angles with respect to an incidence center axis of the splitter means, the incidence center axis being interposed therebetween.

The plurality of collimated light beams is guided along the incidence center axis with the incidence center axis being interposed therebetween. The collimated light beams are thereby reflected by the reflective surfaces of the splitter means to travel and split into the opposite directions with the incidence center axis being interposed therebetween, so that the reflected beams can be guided into the scanned bodies. Moreover, the reflective surfaces are formed of two surfaces and can be readily machined by grinding or the like. This makes it possible to reduce the cost of the parts and thus the manufacturing cost of the imaging device or the like.

Furthermore, particularly for an optical scanner assembly used in a color imaging device, the optical scanner assembly according to the present invention for guiding four collimated light beams into a deflector means and splitting the light beams reflected by the deflector means into four directions by a splitter means to scan each of the light beams across a plurality of scanned bodies is characterized in that the splitter means is formed of two reflective surfaces forming appropriate angles with respect to an incidence center axis of the splitter means, the incidence center axis being interposed therebetween, and two pairs of the four light beams are reflected and split into two directions, and reflective means each arranged for each of the light beams are adapted to guide each of the light beams into corresponding scanned bodies.

Furthermore, the optical scanner assembly according to the present invention is characterized in that the splitter means is shaped in a substantial parallelogram in cross section and employs two surfaces containing two adjacent sides of the parallelogram as reflective surfaces. It is also characterized in that the splitter means is shaped in a substantial square in cross section and employs two surfaces containing two adjacent sides of the square as reflective surfaces.

The parallelogram and square each have two pairs of four surfaces, each pair containing opposite sides parallel to each other. This makes it possible to machine the two parallel pairs by grinding or the like, thereby allowing the reflective surfaces to be finished. This makes it also possible to form the splitter means by straightforward machining and thus reduce the cost of the parts, leading to a decrease in manufacturing cost of an imaging device employing the optical scanner assembly.

Furthermore, the optical scanner assembly according to the present invention is characterized in that the splitter means is formed of two plane mirrors with an edge of one mirror in contact with an edge of the other mirror, the plane mirrors being appropriately angled about a fulcrum on the edges. The optical scanner assembly is also characterized in that the edges are appropriately chamfered, and the two plane mirrors are angled appropriately with the chamfered edges of the two plane mirrors being in contact with each other, and a top is formed on an end portion of the contact portion.

The splitter means can be formed of two reflective surfaces or two plane mirrors angled at an appropriate angle. In this case, the reverse surfaces of the reflective surfaces can be chamfered to bring the chamfered surfaces into contact with each other. This makes it possible to form a top at the contact portion irrespective of the thickness of the plane mirrors.

The nature, principle, and utility of the invention will become more apparent from the following detailed description when read in conjunction with the accompanying drawings in which like parts are designated by like reference numerals or characters.

### BRIEF DESCRIPTION OF THE DRAWINGS

FIG. 1 is a schematic side view illustrating the structure of an optical scanner assembly according to the present invention, the optical scanner assembly being incorporated into an imaging device; FIG. 2 is a front view illustrating the structure of the optical scanner assembly shown in FIG. 1;

FIGS. 3(a) and 3(b) are side views illustrating another example of a splitter means used in the optical scanner assembly;

FIG. 4 is a schematic view illustrating the structure of a prior-art optical scanner assembly, corresponding to FIG. 1;

FIG. 5 is a schematic view illustrating the structure of a prior-art optical scanner assembly, corresponding to FIG. 2; and

FIG. 6 is an explanatory view illustrating the structure of a splitter means used in a prior-art optical scanner assembly.

### DETAILED DESCRIPTION OF THE EMBODIMENTS

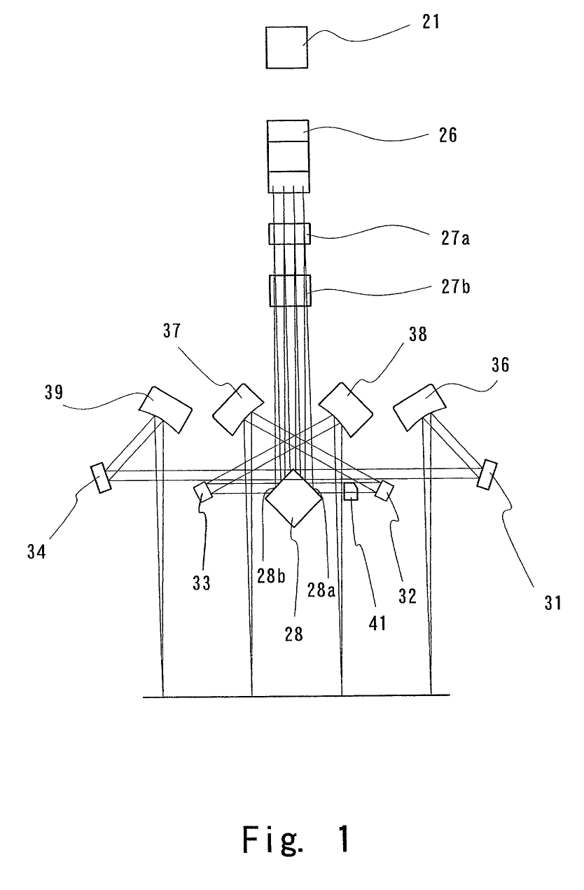

An optical scanner assembly according to the present invention will be specifically explained below in accordance with preferred embodiments illustrated in the accompanying drawings. FIGS. 1 and 2 are explanatory views illustrating the optical scanner assembly. The optical scanner assembly comprises a laser light source 21 formed of a semiconductor laser array or the like for emitting four laser beams each representative of image information of Y, M, C, and BK. There are arranged a collimator lens 22 (FIG. 2) and a cylindrical lens 24 in front of the laser light source 21 to allow the laser beams to be collimated and to be incident upon a first reflector 23. The laser beam reflected by the first reflector 23 is incident upon and is then reflected by a second reflector 25. Subsequently, the laser beam is incident upon a polygonal mirror 26 or a deflector means which has reflectors formed on the substantially equilateral hexagonal sides and which is rotated at an appropriate speed. The laser beam reflected by the polygonal mirror 26 goes through fθ lenses 27a, 27b to be incident upon a splitter means or a multi-sided splitter mirror 28.

The multi-sided splitter mirror 28 has the shape of a substantial square in cross section and is arranged generally in parallel to the radial direction of the polygonal mirror 26. The reflective surfaces 28a, 28b of the multi-sided splitter mirror 28 are formed of surfaces containing two adjacent sides of the square. Accordingly, the other two surfaces that will not serve as reflective surfaces may be chamfered as appropriate to ensure stable mounting. In addition, the top of the reflective surfaces 28a, 28b of the multi-sided splitter mirror 28 is arranged to be sandwiched by the inner two laser beams of the four. The reflective surfaces 28a, 28b are each adjusted to form an angle of 45° with respect to an incidence center axis or a straight line which passes through the top and is parallel to the laser beams. Moreover, the collimator lens 22 and cylindrical lens 24 are adjusted so that the four laser beams are incident upon the multi-sided splitter mirror 28 substantially at equal intervals with each pair of the four laser beams being symmetric with respect to the incidence center axis.

At appropriate positions in the direction of reflection from the reflective surfaces 28a, 28b of the multi-sided splitter mirror 28, there are arranged a first guide mirror 31, a second guide mirror 32, a third guide mirror 33, and a fourth guide mirror 34, with each of the guide mirrors 31-34 being associated with each of the four laser beams. In addition, the first guide mirror 31 and fourth guide mirror 34 as well as the second guide mirror 32 and third guide mirror 33 are arranged to be generally symmetric with respect to the multi-sided splitter mirror 28. The first guide mirror 31 and fourth guide mirror 34 are arranged outside, while the second guide mirror 32 and third guide mirror 33 are arranged inside. Moreover, the first guide mirror 31 and fourth guide mirror 34 are located closer to the polygonal mirror 26 than the second guide mirror 32 and third guide mirror 33. In other words, the four laser beams reflected by the multi-sided splitter mirror 28 are adapted to be incident upon the guide mirrors 31-34, respectively.

A first cylindrical mirror 36, a second cylindrical mirror 37, a third cylindrical mirror 38, and a fourth cylindrical mirror 39 are arranged to be closer to the polygonal mirror 26 than the guide mirrors 31-34. The laser beam reflected by the first guide mirror 31 is incident upon the first cylindrical mirror 36, the reflected beam from the second guide mirror 32 is incident upon the second cylindrical mirror 37, the reflected beam from the third guide mirror 33 is incident upon the third cylindrical mirror 38, and the reflected beam from the fourth guide mirror 34 is incident upon the fourth cylindrical mirror 39, respectively. The laser beams incident upon the cylindrical mirrors 36-39 are reflected therefrom along optical paths generally parallel to each other and then are incident upon image carriers (not shown) such as photosensitive drums or scanned bodies to form electrostatic latent images on the surface thereof.

The guide mirrors 31-34 and cylindrical mirrors 36-39 are arranged such that the optical paths of the four laser beams leading from the laser light source 21 to the image carriers (not shown) have generally the same length. Accordingly, as shown in FIG. 1, across the multi-sided splitter mirror 28, the second cylindrical mirror 37 is arranged opposite to the second guide mirror 32, while the third cylindrical mirror 38 is arranged opposite to the third guide mirror 33.

The image carriers are rotated at appropriate speeds and thus the rotation will cause the positions, where the electrostatic latent images are formed, to change. In addition, the rotation of the polygonal mirror 26 causes the position of the laser beams incident upon the multi-sided splitter mirror 28 to change, which in turn causes the position of the laser beams incident upon the image carriers to change. At this time, it is to be understood that the scan direction produced by a change in the position of the laser beams incident on the image carriers, the change being caused by the rotation of the polygonal mirror 26, is the main scan direction, while the scan direction produced by a change in the position of incidence of the laser beams, the change being caused by the rotation of the image carriers, is the sub scan direction. Moreover, there is provided at an appropriate position a sensor mirror 41 on which a laser beam is incident that is reflected by the reflective surface 28a of the multi-sided splitter mirror 28 outside the scan range in the main scan direction of the multi-sided splitter mirror 28. The laser beam reflected by the sensor mirror 41 is adapted to return to and is incident upon the multi-sided splitter mirror 28. In addition, as shown in FIG. 2, the reflected beam from the sensor mirror 41 is adapted to be reflected by the multi-sided splitter mirror 28 and to be incident upon a scan position sensor 42 arranged near the polygonal mirror 26.

Explained below is the action of embodiments of the optical scanner assembly constructed as described above according to the present invention. The four laser beams emitted from the laser light source 21 pass through the collimator lens 22 and cylindrical lens 24 to be thereby collimated. Then, the beams are sequentially reflected by the first reflector 23 and second reflector 25 to be incident upon the polygonal mirror 26. The polygonal mirror 26, which is rotating, will cause the laser beams to change the direction of reflection with time. In other words, the reflected beams change the position of incidence on the fθ lenses 27a, 27b in accordance with the rotation of the polygonal mirror 26. Subsequently, the laser beams that have passed through the fθ lenses 27a, 27b are incident upon the multi-sided splitter mirror 28. Moreover, in accordance with the rotation of the polygonal mirror 26, the laser beams gradually change the position of incidence on the multi-sided splitter mirror 28 from one edge to the other thereof. At this time, the laser beams are also equidistant parallel beams. Moreover, two pairs of laser beams are incident upon the reflective surfaces 28a, 28b, respectively, with the top of the multi-sided splitter mirror 28 being interposed therebetween, and are symmetric with respect to the incidence center axis.

When the laser beams start to be incident upon the multi-sided splitter mirror 28, part of the laser beams is reflected by the multi-sided splitter mirror 28 to be incident upon the sensor mirror 41, and a reflected beam produced therefrom is again reflected by the multi-sided splitter mirror 28 to be incident upon the scan position sensor 42. Accordingly, the start of scanning by the laser beams is detected.

Two pairs of the four collimated beams are incident upon the reflective surfaces 28a, 28b of the multi-sided splitter mirror 28, respectively, at positions different from each other. Moreover, the reflective surfaces 28a, 28b are arranged at an angle of 45° with respect to the incidence center axis, so that each of the laser beams is reflected substantially at an angle of 90° with respect to the incidence center axis in parallel to each other. For this reason, the four reflected beams are incident upon the first guide mirror 31, second guide mirror 32, third guide mirror 33, and fourth guide mirror 34. The laser beam reflected by the first guide mirror 31 is incident upon the first cylindrical mirror 36 arranged near a diagonal position thereof, while the laser beam reflected by the fourth guide mirror 34 is incident upon the fourth cylindrical mirror 39 arranged near a diagonal position thereof. In addition, the laser beam reflected by the second guide mirror 32 is incident upon the second cylindrical mirror 37 arranged opposite to the second guide mirror 32 across the multi-sided splitter mirror 28. On the other hand, the laser beam reflected by the third guide mirror 33 is incident upon the third cylindrical mirror 38 arranged opposite to the third guide mirror 33 across the multi-sided splitter mirror 28. Subsequently, the laser beams each reflected by the cylindrical mirrors 36, 37, 38, 39 become equidistant collimated beams and are incident upon image carriers such as photosensitive drums (not shown).

Furthermore, the second cylindrical mirror 37 and third cylindrical mirror 38 are arranged opposite to the second guide mirror 32 and third guide mirror 33, respectively, across the multi-sided splitter mirror 28. This ensures appropriate optical path lengths between the second guide mirror 32 and the second cylindrical mirror 37 and between the third guide mirror 33 and the third cylindrical mirror 38, respectively. This therefore makes it possible to provide substantially the same length for the optical path lengths from the cylindrical mirrors 36-39 to image carriers, respectively, thereby providing the same scan radius for the four laser beams. Accordingly, this allows uniform recording of electrostatic latent images on the image carriers. In addition, adjusting the optical path length between the second guide mirror 32 and second cylindrical mirror 37 and between the third guide mirror 33 and third cylindrical mirror 38 will make readily equal the optical path lengths of the four laser beams leading from the laser light source 21 to the image carriers.

The embodiment described above has the multi-sided splitter mirror 28 with the reflective surfaces 28a, 28b formed of two adjacent surfaces of a substantial square. However, the multi-sided splitter mirror can be adapted to have the reflective surfaces formed of two adjacent surfaces of a parallelogram so long as opposite sides thereof are parallel to each other. In other words, even when the multi-sided splitter mirror is shaped in a parallelogram in cross section, opposite surfaces thereof are parallel to each other, thus facilitating machining such as grinding and therefore making it possible to manufacture the multi-sided splitter mirror at low cost.

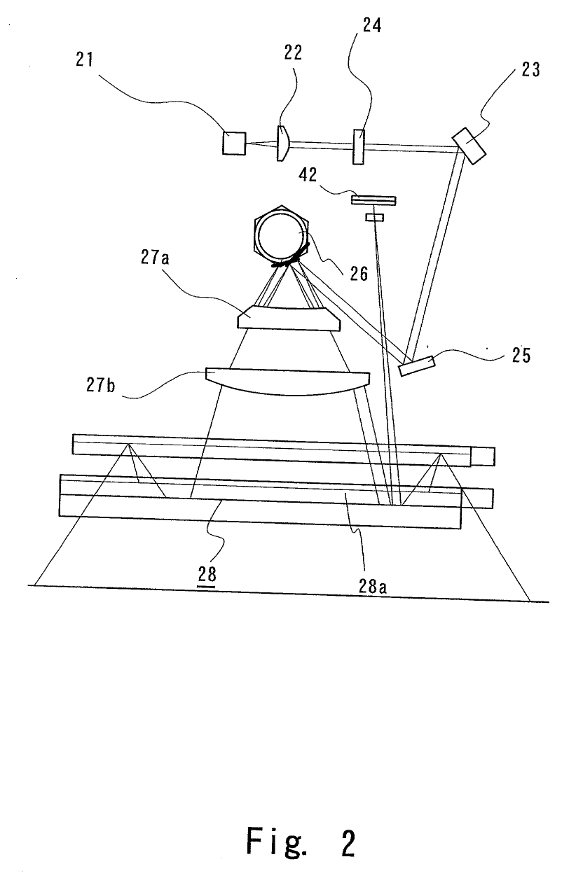

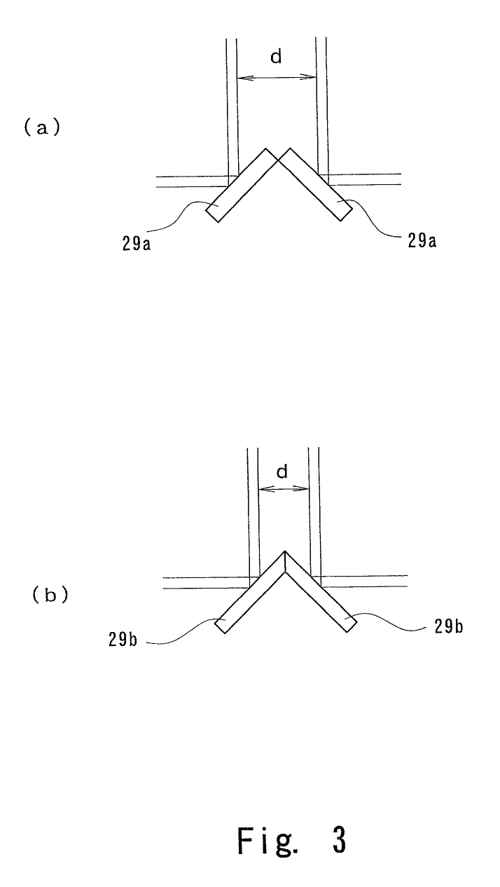

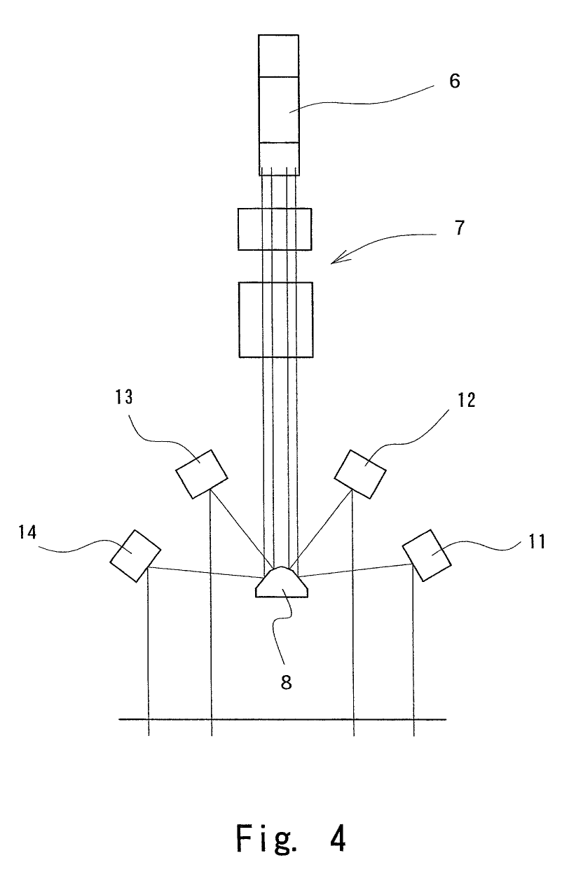

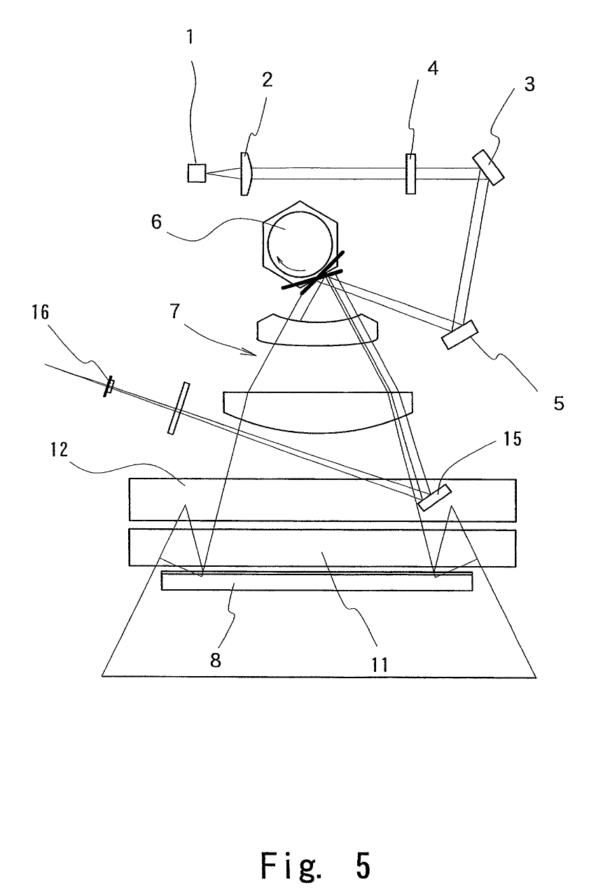

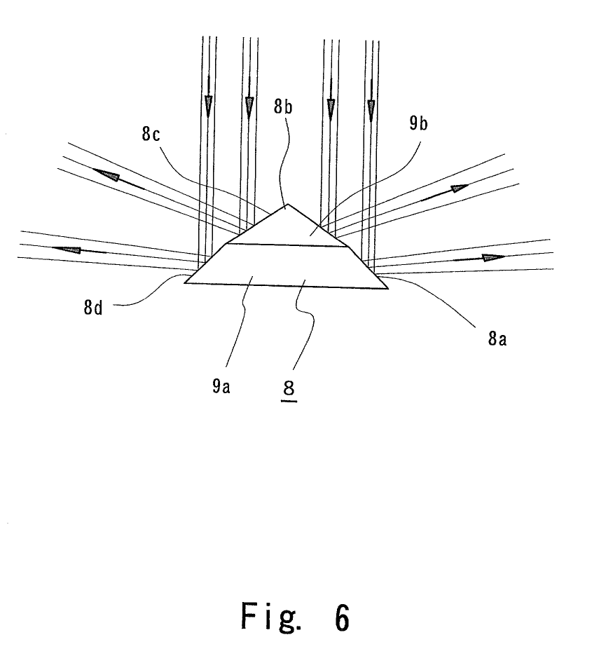

As shown in FIG. 3(a), the same action can be provided not only by the multi-sided splitter mirror 28 having a square or a parallelogram in cross section but also by a multi-sided splitter mirror having two plane mirrors 29a with an edge of one mirror being in contact with an edge of the other mirror at an appropriate angle. With such a structure, however, the contact portion of the two plane mirrors 29a will not form a top due to the thickness of the plane mirrors 29a and the edges of the mirror surfaces are separated from each other, as shown in FIG. 3(a). This will make a distance d larger between two laser beams to be separated by the two plane mirrors 29a, thus requiring a thicker polygonal mirror and fθ lenses. In some cases, this may cause the cost of parts to increase and the optical scanner assembly to increase in size. As shown in FIG. 3(b), the edges of the two plane mirrors 29b can be chamfered, and the chamfered edges can be brought into contact with each other to form a top and decrease the distance d. However, it is difficult to chamfer the edges and the top end portion requires high accuracy, thus possibly causing an increase in cost.

Moreover, the embodiment described above has a structure which allows the multi-sided splitter mirror 28 to split the four laser beams, however, it is also possible to split two or an appropriate number of laser beams. In the case where even numbers of laser beams are split, it is preferable to split the laser beams into the same number of beams on the both sides of the multi-sided splitter mirror.

As described above, the optical scanner assembly according to the present invention has a splitter means which is used for splitting laser beams and formed of two reflective surfaces with the incidence center axis of the splitter means being interposed therebetween, thereby facilitating the formation of the reflective surfaces.

In addition, the optical scanner assembly according to the invention of claim 2 or 3 has the splitter means with the reflective surfaces containing two adjacent sides of a substantial parallelogram or square in cross section. To form the reflective surfaces by grinding or the like, two pairs of parallel surfaces can be shaped to provide highly accurate reflective surfaces. This facilitates shaping and provides reduced cost for the parts, thereby making it possible to reduce manufacturing cost of imaging devices employing the optical scanner assembly.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. An optical scanner assembly for guiding a plurality of light beams into a deflector means and splitting the light beams reflected by said deflector means into a plurality of directions by a splitter means to scan each of the light beams across a plurality of scanned bodies, wherein said splitter means is formed of two reflective surfaces forming predetermined angles with respect to an incidence center axis of said splitter means, the incidence center axis being interposed therebetween.

2. An optical scanner assembly for guiding four collimated light beams into a deflector means and splitting the light beams reflected by said deflector means into four directions by a splitter means to scan each of the light beams across a plurality of scanned bodies, wherein
said splitter means is formed of two reflective surfaces forming predetermined angles with respect to an incidence center axis of said splitter means, the incidence center axis being interposed therebetween, and two pairs of said four light beams are reflected and split into two directions, and
reflective means each arranged for each of the light beams are adapted to guide each of the light beams into corresponding scanned bodies.

3. The optical scanner assembly according to claim 1, wherein said splitter means is shaped as a substantial parallelogram wherein two adjacent sides of said parallelogram are reflective surfaces.

4. The optical scanner assembly according to claim 2, wherein said splitter means is shaped as a substantial parallelogram wherein two adjacent sides of said parallelogram are reflective surfaces.

5. The optical scanner assembly according to claim 1, wherein said splitter means is shaped in a substantial square in cross section wherein two adjacent sides of said square are reflective surfaces.

6. The optical scanner assembly according to claim 2, wherein said splitter means is shaped in a substantial square in cross section wherein two adjacent sides of said square are reflective surfaces.

7. The optical scanner assembly according to claim 1, wherein said splitter means is formed of two planar mirrors with an edge of one mirror in contact with an edge of the other mirror, the plane mirrors being appropriately angled about a fulcrum on said edges.

8. The optical scanner assembly according to claim 2, wherein said splitter means is formed of two planar mirrors with an edge of one mirror in contact with an edge of the other mirror, the plane mirrors being appropriately angled about a fulcrum on said edges.

9. The optical scanner assembly according to claim 7, wherein said edges are appropriately chamfered and the two plane mirrors are angled appropriately with said chamfered edges of the two plane mirrors being in contact with each other, and a top is formed on an end portion of the contact portion.

10. The optical scanner assembly according to claim 8, wherein said edges are appropriately chamfered and the two plane mirrors are angled appropriately with said chamfered edges of the two plane mirrors being in contact with each other, and a top is formed on an end portion of the contact portion.

11. An optical scanner assembly for guiding a plurality of light beams into a deflector means and splitting the light beams reflected by said deflector means into a plurality of directions by a splitter means to scan each of the light beams across a plurality of scanned bodies, wherein said splitter means is formed of two reflective surfaces aligned at about 45° with respect to an incidence center axis of said splitter means, the incidence center axis being interposed therebetween.

12. An optical scanner assembly for guiding four collimated light beams into a deflector means and splitting the light beams reflected by said deflector means into four directions by a splitter means to scan each of the light beams across a plurality of scanned bodies, wherein
said splitter means is formed of two reflective surfaces forming about a 45° angle with respect to an incidence center axis of said splitter means, the incidence center axis being interposed therebetween, and two pairs of said four light beams are reflected and split into two directions, and
reflective means each arranged for each of the light beams are adapted to guide each of the light beams into corresponding scanned bodies.

13. The optical scanner assembly according to claim 11, wherein said splitter means is shaped as a substantial parallelogram wherein two adjacent sides of said parallelogram are reflective surfaces.

14. The optical scanner assembly according to claim 12, wherein said splitter means is shaped as a substantial parallelogram wherein two adjacent sides of said parallelogram are reflective surfaces.

15. The optical scanner assembly according to claim 11, wherein said splitter means is shaped in a substantial square in cross section wherein two adjacent sides of said square are reflective surfaces.

16. The optical scanner assembly according to claim 12, wherein said splitter means is shaped in a substantial square in cross section wherein two adjacent sides of said square are reflective surfaces.

17. The optical scanner assembly according to claim 11, wherein said splitter means is formed of two planar mirrors with an edge of one mirror in contact with an edge of the other mirror, the plane mirrors being appropriately angled about a fulcrum on said edges.

18. The optical scanner assembly according to claim 12, wherein said splitter means is formed of two planar mirrors with an edge of one mirror in contact with an edge of the other mirror, the plane mirrors being appropriately angled about a fulcrum on said edges.

19. The optical scanner assembly according to claim 17, wherein said edges are appropriately chamfered and the two plane mirrors are angled appropriately with said chamfered edges of the two plane mirrors being in contact with each other, and a top is formed on an end portion of the contact portion.

20. The optical scanner assembly according to claim 18, wherein said edges are appropriately chamfered and the two plane mirrors are angled appropriately with said chamfered edges of the two plane mirrors being in contact with each other, and a top is formed on an end portion of the contact portion.
